(19) United States
(12) Patent Application Publication
(10) Pub. No.: US 2025/0238537 A1
(43) Pub. Date: Jul. 24, 2025

(54) ACCESS CONTROL BASED ON CLASSIFICATION OF CHANGED DATA

(71) Applicant: HEWLETT PACKARD ENTERPRISE DEVELOPMENT LP, Spring, TX (US)

(72) Inventors: Omer Uretzky, Herzliya (IL); Gil Barash, Herzliya (IL); Gil Azrielant, Tel Aviv (IL)

(21) Appl. No.: 18/418,551

(22) Filed: Jan. 22, 2024

(51) Int. Cl. G06F 21/62; G06F 16/27; G06F 16/28

(52) U.S. Cl. CPC G06F 21/6218; G06F 16/27; G06F 16/285

(57) ABSTRACT

In some examples, a replication manager detects changed data caused by an input/output (I/O) operation, where the replication manager is to replicate data writes of I/O operations to a storage system. A classifier classifies the changed data to identify a sensitivity of the changed data. A system determines, based on the identified sensitivity of the changed data, an access control rule for a data object comprising the changed data. The system performs access control of the data object based on the determined access control rule.

### BACKGROUND

A ransomware attack involves encrypting data on a computer or on multiple computers connected over a network. In a ransomware attack, data can be encrypted using an encryption key, which renders the data inaccessible to users unless a ransom is paid to obtain the encryption key. A ransomware attack can be highly disruptive to enterprises, including businesses, government agencies, educational organizations, individuals, and so forth.

### BRIEF DESCRIPTION OF THE DRAWINGS

Some implementations of the present disclosure are described with respect to the following figures.

FIG. 1 is a block diagram of a computing arrangement including a computer system and an access security system, according to some examples.

FIG. 2 is a flow diagram of a process of protecting against exfiltration of data, according to some examples.

FIG. 3 is a block diagram of a storage medium storing machine-readable instructions according to some examples.

FIG. 4 is a block diagram of a system according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

A double-extortion ransomware attack may exfiltrate a victim's data and additionally encrypt the data. The attacker then demands payment of a ransom in return for the encryption key to decrypt the encrypted data. The attacker also threatens to disclose the data publicly if the ransom is not paid. As a result, even if the victim is able to recover the encrypted data, such as from a data backup system, the threat of public disclosure of the data (some of which may be sensitive or confidential) may be sufficient leverage to prompt the victim to pay the ransom.

Some ransomware protection systems may be able to detect a ransomware attack based on detecting that unauthorized encryption of data is occurring. However, by the time a ransomware attack is detected based on the detection of data encryption, the attacker may already have retrieved (exfiltrate) the data for possible public exposure. Note that data exfiltration by the attacker occurs before the attacker encrypts the data. Thus, ransomware protection systems or techniques that detect a ransomware attack and that are able to recover original data do not protect against the exfiltration of the data by an attacker.

In accordance with some implementations of the present disclosure, a data protection system is able to protect against unauthorized access of data (e.g., as part of a ransomware attack or any other type of unauthorized access) by classifying data to identify sensitive data, and producing an access control rule based on the identification of the sensitive data to prevent exfiltration of the sensitive data. In some examples of the present disclosure, a replication manager detects changed data caused by one or more input/output (I/O) operations. The replication manager is responsible for replicating data writes of I/O operations to a target storage structure. The data protection system classifies the changed data to identify a sensitivity of the changed data, and determines, based on the identified sensitivity of the changed data, an access control rule for a data object (e.g., a file, an image, a video, or any other container of data) including the changed data. The access control rule can be used to prevent exfiltration of data. As examples, an access control rule can prevent access of data by certain types of users, so that unauthorized users would not be able to access data (which prevents the exfiltration of data). As further examples, an access control rule can restrict access to requests issued from certain programs, machines, or networks.

As used here, “exfiltration” of data can refer to any unauthorized retrieval of data, such as by a ransomware attack or any other form of unauthorized activity. “Changed data” can refer to new data written to a data store, or modified data that updates data already in the data store, or deleted data that removes data from the data store. A “sensitivity” of data can refer to a level of risk or damage that exposure of the data may pose to an owner or manager of the data.

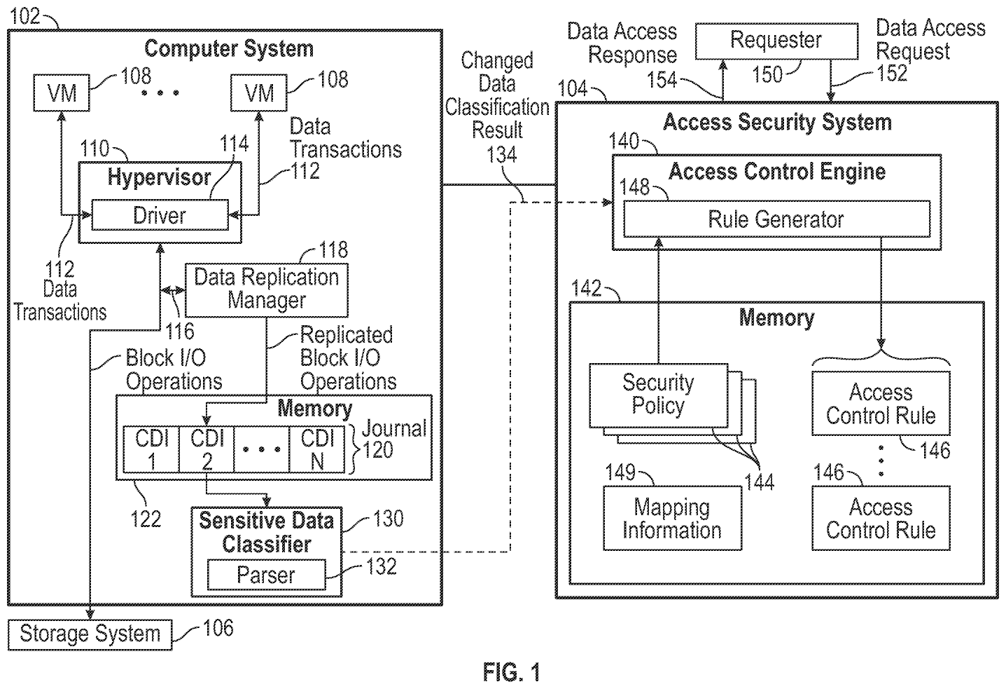

FIG. 1 is a block diagram of an example arrangement that includes a computer system 102 and an access security system 104. Examples of computer systems can include any or some combination of the following: a collection of computers (e.g., server computers, desktop computers, notebook computers, tablet computers, or other types of computers), a collection of smartphones, a collection of Internet of Things (IoT) devices, a collection of household appliances, a collection of vehicles, a collection of game appliances, or a collection of other types of electronic devices. As used here, a “collection” of items can refer to a single item or multiple items.

As discussed further below, in the example of FIG. 1, the computer system 102 includes a data replication manager 118 and a sensitive data classifier 130. The data replication manager 118 and the sensitive data classifier 130 can be implemented using hardware processing circuitry of the computer system 102, or as machine-readable instructions executable on a processing resource of the computer system 102. Although FIG. 1 shows the data replication manager 118 and the sensitive data classifier 130 as being part of the computer system 102, in other examples, the data replication manager 118 and/or the sensitive data classifier 130 may be outside the computer system 102.

The computer system 102 may store data in a storage system 106 coupled to the computer system 102. The storage system 106 may be part of the computer system 102, or may be outside the computer system 102. The storage system 106 can be implemented using a collection of storage devices. Examples of storage devices can include any or some combination of the following: a disk-based storage devices, solid state drive, or other types of storage devices.

The access security system 104 performs access control of data (e.g., data in the storage system 106) associated with the computer system 102 for remote requesters, such as a requester 150. The requester 150 may refer to a human, a program, or a machine.

Although just one computer system 102 is depicted in FIG. 1, it is noted that the access security system 104 can perform access control of data associated with multiple computer systems, in response to requests from remote requesters.

In some examples, the computer system 102 executes one or more programs (including machine-readable instructions) that can perform data transactions that read and write data in the storage system 106. Examples of programs can include virtual entities, such as virtual machines (VMs) 108. A VM refers to a virtualized computing environment that emulates a physical computing environment. A guest operating system (OS) and one or more application programs can execute in a VM 108.

In other examples, other virtual entities executable in the computer system 102 can include containers, which are isolated computing environments in which application programs can execute. In further examples, virtualized computing environments are not implemented in the computer system 102; in such examples, programs can execute in environments provided by a host OS (not shown) of the computer system 102.

In examples where VMs 108 are executed in the computer system 102, a hypervisor 110 is also present in the computer system 102. A hypervisor is also referred to as a virtual machine monitor (VMM). The hypervisor 110 creates and controls execution of the VMs 108. The hypervisor 110 is also responsible for presenting emulated instances of physical resources (e.g., processing resources, storage resources, communication resources, or other resources) of the computer system 102 to each of the VMs 108.

More generally, the hypervisor 110 is an example of a virtualization management program that runs on the computer system 102. Another example of a virtualization management program is a container engine that can start and manage containers in the computer system 102.

The ensuing refers to some examples that employ VMs. Note that techniques or mechanisms according to some examples of the present disclosure may be applied with other types of virtual entities, such as containers, or in computer systems that do not implement virtualized computing environments.

In the example of FIG. 1, a VM 108 can perform data transactions 112 with respect to data in the storage system 106. A data transaction 112 can include reads and writes of data in the storage system 106. A data transaction can be performed in response to a request issued by a VM 108, where the request can include a read request, a write request, or more generally, a request that involves one or more data operations.

In some examples, the hypervisor 110 includes a driver 114 that can split a data transaction 112 into block I/O operations 116. A “driver” can refer to a program that manages access to the storage system 106. In other examples, the driver may be part of a container engine or a host OS of the computer system 102.

A block I/O operation refers to a data operation on a data block, where the data block has a specified size (e.g., 16 megabytes or a different size). Each block I/O operation can read a data block from or write a data block to the storage system 106. In response to requests for the data transactions 112 from the VMs 108, the driver 114 produces the block I/O operations 116 to read and/or write data blocks of the storage system 106.

### Changed Data Classification

The block I/O operations 116 provided by the driver 114 are monitored by the data replication manager 118. The block I/O operations 116 can include write operations (referred to as “write block I/O operations”) and read operations (referred to as “read block I/O operations”). The data replication manager 118 is able to detect the write block I/O operations within the block I/O operations 116. Each block I/O operation has an indicator regarding whether the block I/O operation is a read operation or a write operation. This indicator is used by the data replication manager 118 to determine whether any given block I/O operation involves a read or write of data.

The data replication manager 118 manages the replication of data writes to a target storage structure. A “replication” of a data write can refer to providing a representation of a write I/O operation (or more specifically, a write block I/O operation) that writes data to a storage system (or more specifically to a data block in the storage system), such as the storage system 106. The representation of the write I/O operation can include the changed data that is written (new data or modified data or deleted data) to the storage system. The representation of the write I/O operation can also include information of the type of write operation, such as an insert operation to add new data, or an update operation to update data, or a delete operation to delete data.

The “target storage structure” to which the representation of an write I/O operation is added to replicate a data write can refer to any persistent storage structure that is able to maintain its content when the computer system 102 is power cycled or reset. In some examples, the target storage structure is in the form of a journal 120 stored in a persistent memory 122. A persistent memory refers to a memory that is able to maintain data stored in the memory even if power were removed from the memory. In some examples, the persistent memory 122 is implemented with a collection of persistent memory devices, such as flash memory devices, electrically erasable and programmable read-only memory (EEPROM) devices, or other forms of nonvolatile memory devices.

The journal 120 refers generally to a log that maintains information of write I/O operations. In some examples, the journal 120 does not store information of read I/O operations. The representations of write I/O operations in the journal 120 can be used to recover write data in case the computer system 102 experiences a fault or data in the storage system 106 becomes corrupted.

In other examples, the target storage structure to which data writes are replicated can include a remote replication storage (e.g., a backup storage system) or any other type of storage.

In examples according to FIG. 1, the journal 120 includes a sequence of representations of write block I/O operations. Each representation of a write block I/O operation is depicted as a changed data instance (CDI) in the journal 120 in FIG. 1. Each CDI of the sequence of CDIs (CDI 1, CDI 2, . . . , CDI N, where N≥1) in the journal 120 includes a representation of a write block I/O operation.

In accordance with some implementations of the present disclosure, the sensitive data classifier 130 in the computer system 102 can be used to perform a classification of changed data in each CDI in the journal 120. In some examples, the sensitive data classifier 130 can be triggered to apply the classification of changed data in the CDIs in the journal 120 in response to expiration of a timer. Alternatively, the sensitive data classifier 130 can be triggered to apply the classification of changed data in the CDIs in the journal 120 after a count of CDIs added to the journal 120 exceeds a specified threshold. In other examples, the sensitive data classifier 130 can be triggered in response to other events.

In some examples, the sensitive data classifier 130 can perform a binary classification in which changed data in a CDI is classified as either sensitive or not sensitive. In other examples, the sensitive data classifier 130 is able to assign changed data of a CDI to one of multiple sensitivity levels, with each sensitivity level corresponding to a different sensitivity of the changed data.

More generally, the sensitive data classifier 130 is able to assign M (M≥2) sensitivity levels to changed data in a CDI. If M=2, then the sensitivity levels include a first sensitivity level (e.g., “0”) indicating that the changed data is not sensitive, and a second sensitivity level (e.g., “1”) indicating that the changed data is sensitive. If M>2, then then the sensitivity levels include a first sensitivity level (e.g., “0”) indicating that the changed data is not sensitive, a second sensitivity level (e.g., “1”) indicating that the changed data a lower sensitivity, a third sensitivity level (e.g., “2”) indicating that the changed data a higher sensitivity, and further sensitivity levels if applicable.

In some examples, the sensitive data classifier 130 can perform a content-based analysis of the changed data in a CDI, which determines whether the changed data contains sensitive data. Examples of sensitive data can include a social security number or any other government-issued identifier of a human, an employee number, salary information, personal user information, content marked with certain labels (e.g., a “proprietary” label, a “confidential” label, a “secret” label, etc.), and so forth. Note that certain data may be more sensitive than other data. For example, a social security number may have a higher sensitivity level than a username of a user.

The content-based analysis searches the content of changed data in a CDI to identify presence of sensitive data. The content-based analysis can employ heuristics that can produce solutions (e.g., approximate classifications of sensitive data). Alternatively, the sensitive data classifier 130 may include a machine learning model that can be trained to classify changed data to produce a classification result indicating whether the changed data includes sensitive data.

For each classification of changed data in a CDI, the sensitive data classifier 130 outputs a changed data classification result 134 that is sent to the access security system 104. The changed data classification result 134 can be in the form of a message, an information element, or any other indicator of a sensitive data classification performed by the sensitive data classifier 130. Each changed data classification result 134 can include the classification result for changed data in an individual CDI or changed data in multiple CDIs. The changed data classification result 134 can include an identifier associated with a given CDI (e.g., a data block number of the data block that contains the changed data or any other identifier that distinguishes one CDI from another CDI), as well as a sensitivity level assigned by the sensitive data classifier 130 to the changed data in the given CDI. The changed data classification result 134 may also identify a category of the changed data. In examples where the changed data classification result 134 includes classification results for multiple CDIs, the changed data classification result 134 can include identifiers associated with multiple CDIs and sensitivity levels (and data categories) assigned to respective changed data in the multiple CDIs). The changed data classification result 134 may also include other information as discussed further below.

In other examples, instead of analyzing changed data at the granularity of a CDI, the sensitive data classifier 130 can analyze a larger data object (e.g., a file of a filesystem into which the changed data is to be written, or any other type of data object) that contains changed data of one or more CDIs. A filesystem is used to organize and manage files in a storage system, such as the storage system 106. Files can be stored in various directories of the filesystem. More generally, data may be stored in data objects, which can include files, images, videos, or any other type of data units.

If the sensitive data classifier 130 has the capability to identify which larger data object changed data of a CDI is part of, the sensitive data classifier 130 can perform an analysis of the larger data object to determine whether the larger data object contains sensitive data. In such examples, a changed data classification result 134 that is sent from the sensitive data classifier 130 to the access security system 104 identifies a specific data object (e.g., filename of a file or an identifier of another type of data object) and a sensitivity level assigned by the sensitive data classifier 130 to the data object, as well as a category of the data object.

The following provides an example of how the sensitive data classifier 130 may be able to identify a file that contains changed data of a CDI. Specifically, the sensitive data classifier 130 may be able to perform a mapping between a block I/O operation represented by the CDI and a corresponding file.

The sensitive data classifier 130 can include a parser 132 that determines whether a block I/O operation is part of a filesystem operation. In different examples, the parser 132 may be separate from the sensitive data classifier 130. The determination of whether the block I/O operation includes a filesystem operation can be accomplished by the parser 132 reading a prefix of a command specifying the block I/O operation to determine whether the prefix includes a command identifier (e.g., “FILE”) that is used for filesystem operations. A “command” can refer to a signal, an information element, a message, or any other information that specifies an I/O operation to perform, such as with respect to the storage system 106.

If the parser 132 determines that the block I/O operation is part of a filesystem operation, the parser 132 can extract a collection of attributes (a single attribute or multiple attributes) from the command for the block I/O operation. For example, the command may include delimiters, which can be identified by the parser 132 to extract fields corresponding to the delimiters. A “delimiter” refers to an indication (e.g., a specified string of characters or a symbol) in the command that indicates a separate field in the command. The collection of data fields can include an identifier of the file that is the subject of the block I/O operation. The collection of data fields may also identify a directory that the file is part of. The extracted information of the file can be provided by the parser 132 to the sensitive data classifier 130, which can then apply a sensitivity classification to the file.

Further details regarding mapping block I/O operations to files can be found in U.S. patent application Ser. No. 18/495,142, entitled “Filesystem Operations in Storage Devices,” filed Oct. 26, 2023.

More generally, the parser 132 can read a portion of a command specifying a block I/O operation to determine whether the command contains an indication that the command is used for an operation involving a data object. If so, the parser 132 can identify the data object based on further information in the command.

### Access Security Based on Sensitivity Classification

The following describes how the access security system 104 processes changed data classification results 134 from the sensitive data classifier 130. The access security system 104 can be implemented using one or more computers. In some examples, the access security system 104 may be part of a cloud computing environment, or a data center, or any other computing environment.

The access security system 104 includes an access control engine 140 and a memory 142. As used here, an “engine” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, an “engine” can refer to a combination of one or more hardware processing circuits and machine-readable instructions (software and/or firmware) executable on the one or more hardware processing circuits.

In some examples, the access control engine 140 can implement access control using the Zero Trust Network Access (ZTNA) model. With ZTNA, authentication of a requester (e.g., 150) occurs before the requester can be permitted access to data. If implementing ZTNA, the access control engine 140 can perform authentication and authorization to authenticate requesters and to authorize activities of the requesters. In other examples, the access control engine 140 may employ other types of access control techniques.

The memory 142 can store various security policies 144. Different security policies may be applied for different scenarios, which can be based on one or more factors, including the sensitivity level of changed data (changed data of a collection of CDIs or changed data in a larger data object containing the changed data of a collection of CDIs), and possibly additional factor(s) such as any or some combination of the following: a category of the changed data, a computing environment in which data writes are performed, a protocol that is employed, an identifier of an entity (e.g., a VM, a container, a program, a user, etc.) that requested a data write, a location of an entity that requested a data write, a time of a data write, or other factors.

The sensitivity level of changed data is provided in a changed data classification result 134 received by the access control engine 140 from the sensitive data classifier 130. A category of changed data can refer to a type of data of the changed data, such as the following categories: basic personally identifiable information (PII), medical data, company confidential information, and so forth.

A computing environment in which data writes are performed can refer to a server computer, a virtualized computing environment, or any other type of computing environment. The computing environment may be identified by an identifier of the computing environment, such as an identifier (e.g., a network address or other identifier) of a server computer, a VM identifier, or any other type of identifier.

Examples of protocols that may be employed in data writes include any or some combination of the following: a Remote Desktop Protocol (RDP), a File Transfer Protocol (FTP), a Secure Shell (SSH) protocol, a Hypertext Transfer Protocol (HTTP), or any other protocol.

In some examples, different security policies may be applied for different sensitivity levels as well as for categories of data, for different computing environments, and/or for different protocols. A security policy may include a collection of conditions and a collection of actions to perform if the collection of conditions applies. For example, security policies may have the following forms:
(1) If Sensitivity Level 1 [condition] and Data Category u [condition], perform access control action A [action];
(2) If Sensitivity Level 2 [condition] and Server X [condition], perform access control action B [action];
(3) If Sensitivity Level 1 [condition] and Data Category v [condition] and FTP used [condition], perform access control action C [action];
(4) If Sensitivity Level 3 [condition] and Server Y [condition] and SSH used [condition], perform access control actions D, E [actions].

Security policy (1) specifies that access control action A is to be applied if classified changed data has Sensitivity Level 1 and the category of the changed data is Data Category u. Security policy (2) specifies that access control action B is to be applied if classified changed data has Sensitivity Level 2 and data writes are occurring on Server X. Security policy (3) specifies that access control action C is to be applied if classified changed data has Sensitivity Level 1, the category of the changed data is Data Category v, and the FTP protocol is used. Security policy (4) specifies that access control actions D and E are to be applied if classified changed data has Sensitivity Level 3, data writes are occurring on Server Y, and the SSH protocol is used.

An “access control action” refers to an action performed to control access to data in response to a data access request, such as a data access request 152 from the requester 150. For example, access control action A is an action that prevents downloads of data by a non-administrative user. As another example, access control action B is an action that prevents reads and writes of data by a non-administrative user. As a further example, access control action D prevents any writes of data by any user, and access control action E prevents reads of data by a non-administrative user.

A rule generator 148 can create access control rules 146 based on the various security policies 144. In some examples, the rule generator 148 is part of the access control engine 140 (e.g., implemented using hardware processing circuitry of the access control engine 140 or implemented with machine-readable instructions executed by the access control engine 140). In other examples, the rule generator 148 is separate from the access control engine 140. The access control rules 146 created by the rule generator 148 are stored in the memory 142.

In response to receiving a changed data classification result 134 from the sensitive data classifier 130, the rule generator 148 selects, from among the security policies 144 in the memory 142, a given security policy that is applicable to the conditions associated with the changed data classification result 134. The conditions can include any or some combination of the following: a sensitivity level of changed data, a category of the changed data, a computing environment in which data writes are performed, a protocol that is employed, an identifier of an entity that requested a data write, a location of an entity that requested a data write, a time of a data write, or other factors. The changed data classification result 134 may include any or some combination of the foregoing information (e.g., sensitivity level, category, computing environment, protocol, requesting entity, requesting entity location, time, etc.) used by the rule generator 148 to determine which security policy is applicable.

The rule generator 148 then creates an access control rule 146 based on the given security policy. “Creating” an access control rule 146 based on a security policy 144 can refer to generating the access control rule 146 that contains the action(s) of the security policy 144. For example, the access control rule generated based on security policy (1) includes access control action A. As another example, the access control rule generated based on security policy (4) includes access control actions D and E.

The access control rules 146 are associated with respective data objects (e.g., files) in the storage system 106. For example, the access control engine 140 can maintain mapping information 149 that correlates data objects to access control rules. In some examples, a changed data classification result 134 from the sensitive data classifier 130 can include an identifier of a data object that the changed data classification result 134 is associated with. As discussed above, the parser 132 can map a write block I/O operation to a respective data object. An access control rule 146 generated in response to the changed data classification result 134 is correlated, in the mapping information 149, to the data object identified by the changed data classification result 134.

The access control engine 140 uses an applicable access control rule 146 to process a data access request (e.g., 152) from a requester (e.g., 150) for a given data object. The access control engine 140 determines based on the applicable access control rule whether to grant or reject the data access request 152. If the data access request 152 is granted, then the access control engine 140 allows the data access request 152 to be passed to the computer system 102, which performs a data transaction based on the data access request 152.

However, if the data access request 152 is rejected based on the applicable access control rule, the access control engine 140 prevents the data access request 152 from being passed to the computer system 102, and can simply drop the data access request 152. The access control engine 140 provides a data access response 154 to the requester 150, where the data access response 154 can include a successful result for the data access request 152 if the data access request 152 were granted by the access control engine 140, or the data access response 154 can include a failure indication for the data access request 152 if the data access request 152 were rejected by the access control engine 140.

The applied access control rules 146 can prevent attempts at exfiltrating data objects, such as those stored in the storage system 106. The applied access control rules 146 can also prevent encryption of data, such as by blocking writes of data. In this manner, data security is enhanced and ransomware attacks or other forms of attacks can be blocked or made less likely to succeed.

### FURTHER EXAMPLES

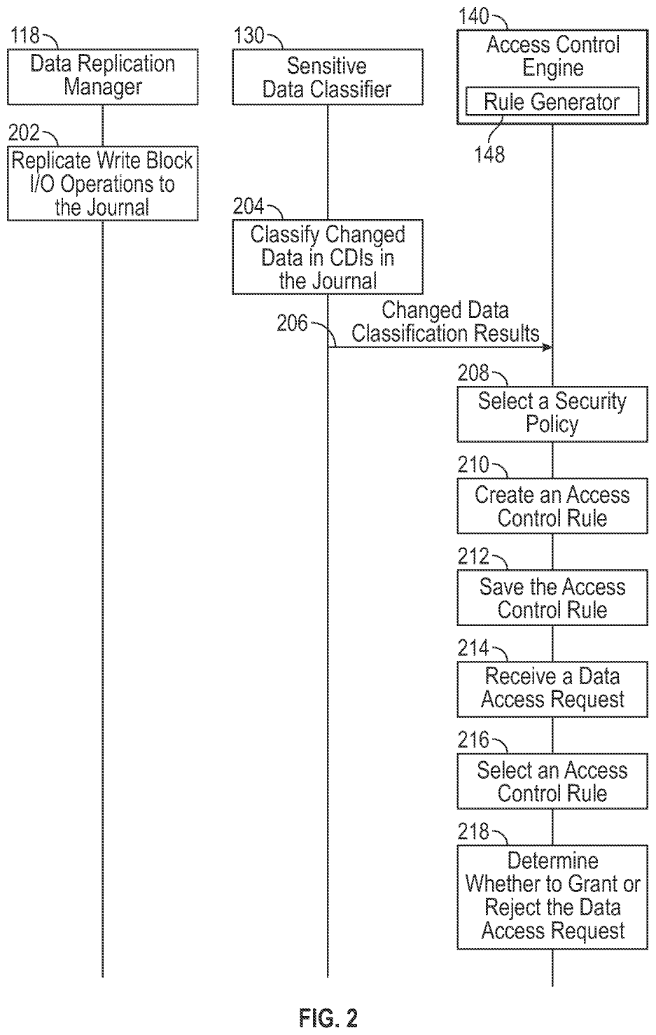

FIG. 2 is a flow diagram of a process performed by the data replication manager 118, the sensitive data classifier 130, and the access control engine 140, according to some examples. Although FIG. 2 shows a specific order of tasks, in other examples, the tasks can be performed in a different order, some of the tasks may be omitted, and other tasks may be added.

The data replication manager 118 replicates (at 202) write block I/O operations to the journal 120 (FIG. 1), by adding respective CDIs to the journal 120, for example. When triggered, the sensitive data classifier 130 classifies (at 204) changed data in the CDIs (or alternatively, classifies data objects containing changed data in the CDIs).

The sensitive data classifier 130 outputs (at 206) changed data classification results (e.g., 134 in FIG. 1) to the access control engine 140. A changed data classification result 134 can include the classification result for changed data in a CDI or changed data in a data object. The changed data classification result 134 can include an identifier associated with a given CDI (or a data object), as well as a sensitivity level assigned by the sensitive data classifier 130 to the changed data. The changed data classification result 134 may also identify a category of the changed data.

The rule generator 148 in the access control engine 140 selects (at 208) a security policy (from among multiple security policies 144) based on conditions that apply for a received changed data classification result 134. As noted above, the conditions can be based on any or some combination of the following factors: sensitivity level of the changed data, a category of the changed data, a computing environment in which data writes are performed, a protocol that is employed, an identifier of an entity that requested a data write, a location of an entity that requested a data write, a time of a data write, or other factors. Thus, the security policy selected is the security policy including conditions applicable to the received changed data classification result 134.

Based on the selected security policy, the rule generator 148 creates (at 210) an access control rule, which includes the access control action(s) of the selected security policy. The rule generator 148 saves (at 212) the access control rule in a memory (e.g., 142 in FIG. 1). The rule generator 148 can also update the mapping information 149 that correlates the access control rule to a respective data object.

The access control engine 140 receives (at 214) a data access request, such as from a requester (e.g., 150 in FIG. 1). The access control engine 140 selects (at 216) an access control rule to apply based on the data object sought by the data access request. For example, the access control engine 140 can access the mapping information 149 to determine which access control rule is applicable for the data object. The access control engine 140 determines (at 218) whether to grant or reject the data access request based on the selected access control rule.

In some examples, the classification of sensitive data and the generation of access control rules for sensitive data can be performed in “real time,” i.e., performed as I/O operations that write data to a storage system are occurring. Performing the sensitive data classification and the access control rule generation in “real time” is contrasted to an offline process in which the sensitive data classification and the access control rule generation are performed some amount of time after data writes have already occurred. Such offline process may not be able to prevent exfiltration of data, since an attack may already have occurred by the time the offline process is performed. The generation of access control rules in real time allows data exfiltration attempts to be thwarted.

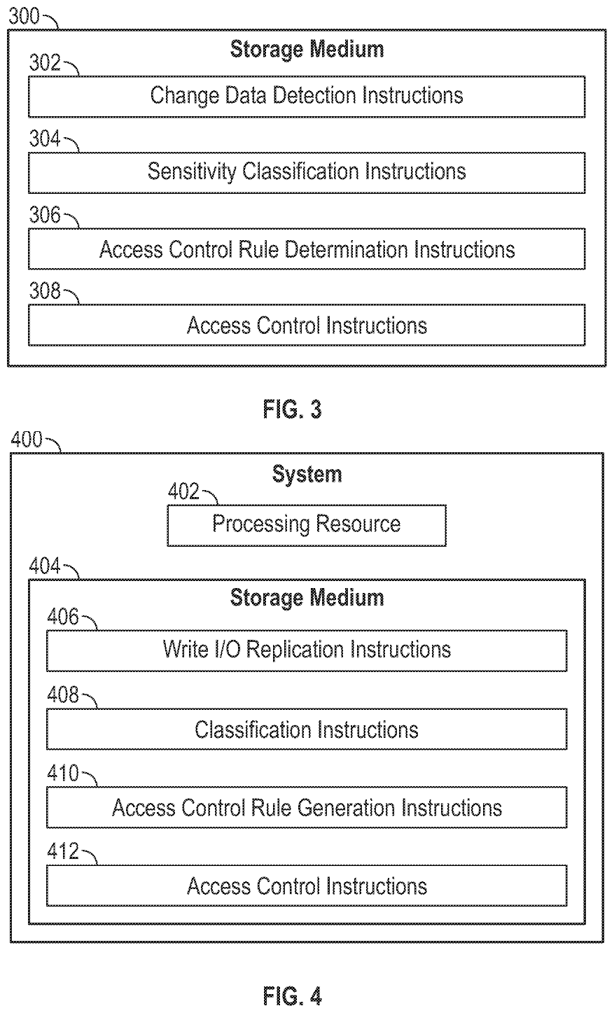

FIG. 3 is a block diagram of a non-transitory machine-readable or computer-readable storage medium 300 storing machine-readable instructions that upon execution cause a system to perform various tasks. The system may include the computer system 102 and the access security system 104 of FIG. 1, for example.

The machine-readable instructions include changed data detection instructions 302 to detect, using a replication manager, changed data caused by an I/O operation. The replication manager replicates data writes of I/O operations to a storage system. An example of the replication manager is the data replication manager 118 of FIG. 1. The detecting of changed data can be based on identifying write I/O operations in a sequence of I/O operations (e.g., the block I/O operations 116 in FIG. 1).

The machine-readable instructions include sensitivity classification instructions 304 to classify the changed data to identify a sensitivity of the changed data. The sensitivity classification instructions 304 may be part of the sensitive data classifier 130 of FIG. 1, for example. Classifying the changed data can refer to classifying changed data in one or more CDIs of the journal 120, for example, or classifying a data object (e.g., a file) that contains the changed data.

The machine-readable instructions include access control rule determination instructions 306 to determine, based on the identified sensitivity of the changed data, an access control rule for a data object including the changed data. The access control rule may be generated by the rule generator 148 of FIG. 1, for example. The generated access control rule can further be based on one or more other factors.

The machine-readable instructions include access control instructions 308 to perform access control of the data object based on the determined access control rule. The access control instructions 308 may be part of the access control engine 140 of FIG. 1, for example.

In some examples, the classifying of the changed data includes identifying a sensitivity level, from among a plurality of sensitivity levels, of the changed data. The identified sensitivity level may be for changed data in one or more CDIs, or for a data object containing the changed data.

In some examples, the determining of the access control rule for the data object is based on a security policy (e.g., 144 in FIG. 1) for the identified sensitivity level. Different sensitivity levels are associated with different security policies relating to access control.

In some examples, the determining of the access control rule for the data object is further based on a category of changed data.

In some examples, the determining of the access control rule for the data object is further based on one or more additional factors selected from among: an identifier of a computing environment, a protocol employed, an identifier of an entity that requested a data write, a location of an entity that requested a data write, or a time of a data write.

In some examples, the security policy includes one or more conditions and one or more access control actions to apply if the one or more conditions are satisfied. The determining of the access control rule includes including the one or more access control actions in the access control rule.

In some examples, the classifying of the changed data includes classifying a first data object containing the changed data, where the identified sensitivity of the changed data is a sensitivity of the first data object.

In some examples, the machine-readable instructions map the I/O operation causing the changed data to the first data object. The mapping can include reading a portion of a command specifying the write I/O operation to determine that the command contains an indication that the command is used for an operation involving a data object, and identifying the first data object based on further information in the command.

FIG. 4 is a block diagram of a system 400 according to some examples. The system 400 includes a processing resource 402, which includes one or more hardware processors. A hardware processor can include a microprocessor, a core of a multi-core microprocessor, a microcontroller, a programmable integrated circuit, a programmable gate array, or another hardware processing circuit.

The system 400 includes a storage medium 404 storing machine-readable instructions executable by the processing resource 402 to perform various tasks. The machine-readable instructions in the storage medium 404 include write I/O replication instructions 406 to replicate write I/O operations as representations added to a log. The representations can be in the form of CDIs added to the journal 120 of FIG. 1, for example.

The machine-readable instructions in the storage medium 404 include classification instructions 408 to classify, using a classifier, changed data in the representations to identify a sensitivity level of the changed data in each respective write I/O operation of the write I/O operations. The classifying of the changed data in the respective write I/O operation produces a sensitivity classification result.

The machine-readable instructions in the storage medium 404 include access control rule generation instructions 410 to generate a first access control rule for a first data object containing changed data in a first write I/O operation of the write I/O operations. The first access control rule is based on a first sensitivity level assigned by the classifier to the changed data in the first write I/O operation. The first access control rule may also be based on other factor(s).

The machine-readable instructions in the storage medium 404 include access control instructions 412 to perform access control of the first data object based on the first access control rule.

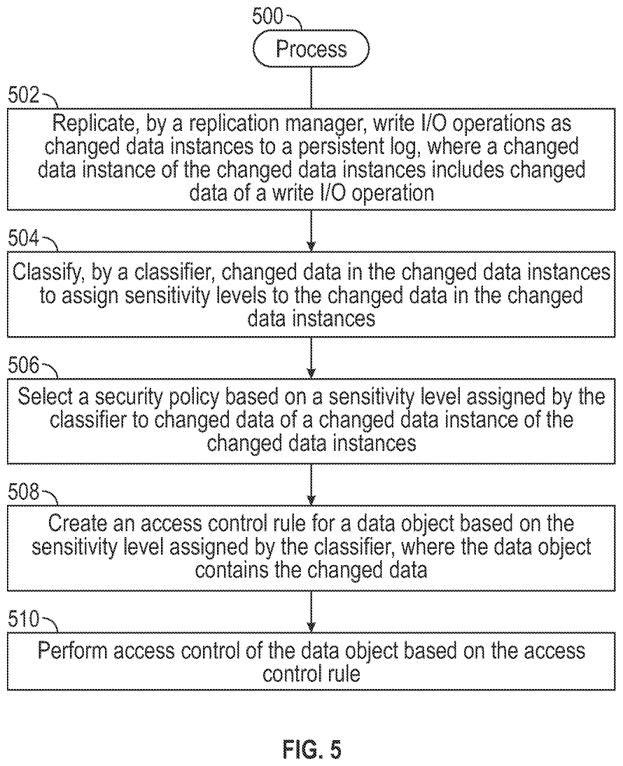

FIG. 5 is a flow diagram of a process 500 according to some examples. The process 500 may be performed by the data replication manager 118, the sensitive data classifier 130, and the access control engine 140 of FIG. 1, for example.

The process 500 includes replicating (at 502), by a replication manager, write I/O operations as changed data instances to a persistent log. A changed data instance of the changed data instances includes changed data of a write I/O operation. An example of the persistent log is the journal 120 of FIG. 1, for example.

The process 500 includes classifying (at 504), by a classifier, changed data in the changed data instances to assign sensitivity levels to the changed data in the changed data instances. The sensitivity levels can include two or more sensitivity levels.

The process 500 includes selecting (at 506) a security policy based on a sensitivity level assigned by the classifier to changed data of a changed data instance of the changed data instances. The security policy selected can further be based on other factors. The selection of the security policy may be performed by the rule generator 148, for example.

The process 500 includes creating (at 508) an access control rule for a data object based on the sensitivity level assigned by the classifier, where the data object contains the changed data. The creation of the access control rule may be performed by the rule generator 148, for example.

The process 500 includes performing (at 510) access control of the data object based on the access control rule. The access control is for a data access request received from a requester.

A storage medium (e.g., 300 in FIG. 3 or 404 in FIG. 4) can include any or some combination of the following: a semiconductor memory device such as a dynamic or static random access memory (a DRAM or SRAM), an erasable and programmable read-only memory (EPROM), an EEPROM, and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a system to:
detect, using a replication manager, changed data caused by an input/output (I/O) operation, the replication manager to replicate data writes of I/O operations to a storage system;
classify the changed data to identify a sensitivity of the changed data;
determine, based on the identified sensitivity of the changed data, an access control rule for a data object comprising the changed data; and
perform access control of the data object based on the determined access control rule.

2. The non-transitory machine-readable storage medium of claim 1, wherein the classifying of the changed data comprises identifying a sensitivity level, from among a plurality of sensitivity levels, of the changed data.

3. The non-transitory machine-readable storage medium of claim 2, wherein the determining of the access control rule for the data object is based on a security policy for the identified sensitivity level.

4. The non-transitory machine-readable storage medium of claim 3, wherein different sensitivity levels are associated with different security policies relating to access control.

5. The non-transitory machine-readable storage medium of claim 3, wherein the determining of the access control rule for the data object is further based on a category of changed data.

6. The non-transitory machine-readable storage medium of claim 3, wherein the determining of the access control rule for the data object is further based on one or more additional factors selected from among: an identifier of a computing environment, a protocol employed, an identifier of an entity that requested a data write, a location of an entity that requested a data write, or a time of a data write.

7. The non-transitory machine-readable storage medium of claim 3, wherein the security policy comprises one or more conditions and one or more access control actions to apply if the one or more conditions are satisfied, and wherein the determining of the access control rule comprises including the one or more access control actions in the access control rule.

8. The non-transitory machine-readable storage medium of claim 1, wherein the classifying of the changed data comprises classifying a first data object containing the changed data, the identified sensitivity of the changed data being a sensitivity of the first data object.

9. The non-transitory machine-readable storage medium of claim 8, wherein the instructions upon execution cause the system to:
map the I/O operation causing the changed data to the first data object.

10. The non-transitory machine-readable storage medium of claim 1, wherein the detecting of the changed data comprises:
receiving, by the replication manager, a plurality I/O operations; and
identifying I/O operations of the plurality of I/O operations that perform data writes.

11. The non-transitory machine-readable storage medium of claim 10, wherein the plurality of I/O operations comprise block I/O operations, and the data writes performed by the identified I/O operations comprise writes of data blocks.

12. The non-transitory machine-readable storage medium of claim 11, wherein data writes of the identified I/O operations are replicated as changed data instances to a journal in a persistent memory.

13. The non-transitory machine-readable storage medium of claim 12, wherein the classifying of the changed data comprises classifying the changed data in a changed data instance in the journal.

14. The non-transitory machine-readable storage medium of claim 12, wherein each changed data instance of the changed data instances comprises a representation of a data write.

15. A system comprising:
a processing resource; and
a non-transitory storage medium storing instructions executable by the processing resource to:
replicate write input/output (I/O) operations as representations added to a log;
classify, using a classifier, changed data in the representations to identify a sensitivity level of the changed data in each respective write I/O operation of the write I/O operations, the classifying of the changed data in the respective write I/O operation producing a sensitivity classification result;
generate a first access control rule for a first data object containing changed data in a first write I/O operation of the write I/O operations, the first access control rule being based on a first sensitivity level assigned by the classifier to the changed data in the first write I/O operation; and
perform access control of the first data object based on the first access control rule.

16. The system of claim 15, wherein a representation of the representations added to the log comprises changed data of a respective write I/O operation.

17. The system of claim 15, wherein the instructions are executable by the processing resource to:
generate a second access control rule for a second data object containing changed data in a second write I/O operation of the write I/O operations, the second access control rule being based on a second sensitivity level assigned by the classifier to the changed data in the second write I/O operation; and
perform access control of the second data object based on the second access control rule.

18. The system of claim 15, wherein the instructions are executable by the processing resource to:
map the changed data in the first write I/O operation to the first data object based on:
reading a portion of a command specifying the first write I/O operation to determine that the command contains an indication that the command is used for an operation involving a data object, and
identifying the first data object based on further information in the command.

19. A method comprising:
replicating, by a replication manager, write input/output (I/O) operations as changed data instances to a persistent log, wherein a changed data instance of the changed data instances comprises changed data of a write I/O operation;
classifying, by a classifier, changed data in the changed data instances to assign sensitivity levels to the changed data in the changed data instances;
selecting, by a system comprising a hardware processor, a security policy based on a sensitivity level assigned by the classifier to first changed data of a first changed data instance of the changed data instances;
creating, by the system, an access control rule for a data object based on the sensitivity level assigned by the classifier, wherein the data object contains the first changed data; and
performing, by the system, access control of the data object based on the access control rule.

20. The method of claim 19, comprising:
mapping the first changed data to the data object based on:
reading a portion of a command specifying a write I/O operation involving the first changed data to determine that the command contains an indication that the command is used for an operation involving a data object, and
identifying the data object based on further information in the command.
